(19) United States
(12) Patent Application Publication
(10) Pub. No.: US 2019/0349531 A1
(43) Pub. Date: Nov. 14, 2019

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: Michio Aizawa, Yokohama-shi (JP)

(21) Appl. No.: 16/399,158

(22) Filed: Apr. 30, 2019

(30) Foreign Application Priority Data
May 9, 2018 (JP) 2018-090367

(51) Int. Cl. H04N 5/232; H04N 5/222; G06T 7/73

(52) U.S. Cl. CPC H04N 5/23299; G06T 7/73; H04N 5/2226; H04N 5/23216

(57) ABSTRACT

An information processing apparatus includes a specifying unit configured to specify, based on a user operation, at least one of a position and a direction of a virtual viewpoint for generating a virtual viewpoint image, the virtual viewpoint image being generated based on images that are obtained by image capturing in a plurality of directions with a plurality of image capturing apparatuses, and a display control unit configured to cause a display unit to display information indicating a relationship between at least one of the position and the direction of the virtual viewpoint and an image quality of the virtual viewpoint image together with the virtual viewpoint image.

### BACKGROUND

### Field

The present disclosure relates to an information processing apparatus, an information processing method, and a storage medium.

### Description of the Related Art

Attention is paid to a technique to generate a virtual viewpoint image by using a multi-viewpoint image that is obtained by synchronous photographing (image capturing) at multiple viewpoints from plural directions with cameras (image capturing apparatuses) arranged at different positions. It can be said that the virtual viewpoint image is an image viewed from a viewpoint (virtual viewpoint) of a camera that is virtual (referred to below as a virtual camera). The technique to generate the virtual viewpoint image enables a user to see, for example, a highlight scene of a soccer or basketball game from various angles and can give the user more realistic feeling than a normal image.

Japanese Patent Laid-Open No. 2015-219882 describes a technique to generate a virtual viewpoint image by operating a virtual camera. Specifically, according to the technique, the image capturing direction of the virtual camera is set on the basis of a user operation, and the virtual viewpoint image is generated on the basis of the image capturing direction of the virtual camera.

In some cases where the virtual viewpoint image is generated on the basis of photographed images that are obtained by cameras, there is a possibility that the image quality of the generated virtual viewpoint image is reduced depending on the arrangement of the cameras and the position and direction of the virtual viewpoint. In the case of the technique that is described in Japanese Patent Laid-Open No. 2015-219882, a user cannot know whether the image quality of a virtual viewpoint image related to a virtual viewpoint specified by the user is reduced until the virtual viewpoint image related to the virtual viewpoint is generated and displayed, and there is a risk that the image quality of the generated virtual viewpoint image is low against expectations of the user.

### SUMMARY

According to an aspect of the present disclosure, an information processing apparatus includes a specifying unit configured to specify, based on a user operation, at least one of a position and a direction of a virtual viewpoint for generating a virtual viewpoint image, the virtual viewpoint image being generated based on images that are obtained by image capturing in a plurality of directions with a plurality of image capturing apparatuses, and a display control unit configured to cause a display unit to display information indicating a relationship between at least one of the position and the direction of the virtual viewpoint and an image quality of the virtual viewpoint image together with the virtual viewpoint image.

Further features will become apparent from the following description of exemplary embodiments with reference to the attached drawings.

### BRIEF DESCRIPTION OF THE DRAWINGS

FIG. 1A schematically illustrates the structure of an image-processing system and FIG. 1B schematically illustrates the structure of a backend server.

FIG. 2 illustrates an example of the structure of a virtual-viewpoint-specifying device.

FIG. 3 illustrates a functional configuration to generate and overlay a gaze-point indicator.

FIG. 4A to FIG. 4C illustrate examples of a position at which the gaze-point indicator is displayed.

FIG. 5A to FIG. 5F illustrate examples of the shape of the gaze-point indicator.

FIG. 6A and FIG. 6B illustrate examples of display of the gaze-point indicator.

FIG. 7 is a flowchart from generation of the gaze-point indicator to overlaying of the gaze-point indicator.

FIG. 8 illustrates a functional configuration to generate and overlay a foreground indicator.

FIG. 9A and FIG. 9B illustrate examples of display of the foreground indicator.

FIG. 10 is a flowchart from generation of the foreground indicator to overlaying of the foreground indicator.

FIG. 11A illustrates a functional configuration to generate and overlay a direction indicator, FIG. 11B illustrates a functional configuration to generate and overlay a posture indicator, and FIG. 11C illustrates a functional configuration to generate and overlay an altitude indicator.

FIG. 12A to FIG. 12D illustrate examples of the direction indicator, the posture indicator, and the altitude indicator.

FIG. 13 is a flowchart of generating and processing the direction indicator, the posture indicator, and the altitude indicator.

### DESCRIPTION OF THE EMBODIMENTS

An embodiment of the present disclosure will hereinafter be described in detail with reference to the drawings. The embodiment described below is an example when the present disclosure is specifically carried out, and the present disclosure is not limited thereto.

### System Structure

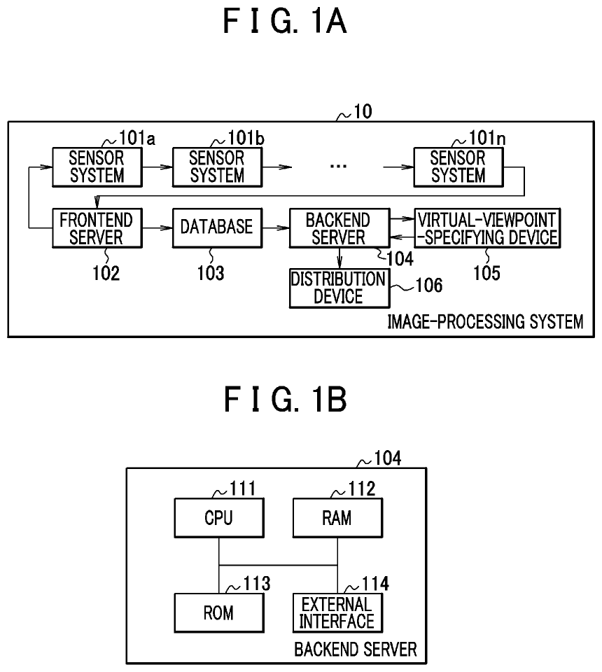

FIG. 1A schematically illustrates an example of the overall structure of an image-processing system 10 to which an information processing apparatus according to the present embodiment is applied.

The image-processing system 10 includes sensor systems 101a, 101b, 101c, . . . 101n. According to the present embodiment, the sensor systems are not distinguished and are referred to as sensor systems 101 unless otherwise particularly described. The image-processing system 10 further includes a frontend server 102, a database 103, a backend server 104, a virtual-viewpoint-specifying device 105, and a distribution device 106.

Each of the sensor systems 101 includes a digital camera (image capturing apparatus, referred to below as a physical camera) and a microphone (referred to below as a physical microphone). The physical cameras of the sensor systems 101 face different directions and synchronously photograph. The physical microphones of the sensor systems 101 collect sounds in different directions and sounds near the positions at which the physical microphones are disposed.

The frontend server 102 obtains data of photographed images that are photographed in different directions by the physical cameras of the sensor systems 101 and outputs the photographed images to the database 103. The frontend server 102 also obtains data of sounds that are collected by the physical microphones of the sensor systems 101 and outputs the data of the sounds to the database 103. According to the present embodiment, the frontend server 102 obtains the data of the photographed images and the data of the sounds via the sensor systems 101n. However, the frontend server 102 is not limited thereto and may obtain the data of the photographed images and the data of the sounds directly from the sensor systems 101. In the following description, image data that is sent and received between components is referred to simply as an “image”. Similarly, sound data is referred to simply as a “sound”.

The database 103 stores the photographed images and the sounds that are received from the frontend server 102. The database 103 outputs the stored photographed images and the stored sounds to the backend server 104 in response to a request from the backend server 104.

The backend server 104 obtains viewpoint information indicating the position and direction of a virtual viewpoint that are specified on the basis of a user operation from the virtual-viewpoint-specifying device 105 described later, and generates an image at the virtual viewpoint corresponding to the specified position and the specified direction. The virtual-viewpoint-specifying device 105 has a specifying unit function. The virtual-viewpoint-specifying device 105 configured to specify, based on a user operation, at least one of a position and a direction of a virtual viewpoint for generating a virtual viewpoint image. The backend server 104 also obtains position information about a virtual sound collection point that is specified by an operator from the virtual-viewpoint-specifying device 105 and generates a sound at the virtual sound collection point corresponding to the position information.

The position of the virtual viewpoint and the position of the virtual sound collection point may differ from each other or may be the same. According to the present embodiment, for simplicity of description, the position of the virtual sound collection point that is specified relative to the sound is the same as the position of the virtual viewpoint that is specified relative to the image. In the following description, the position is referred to simply as the “virtual viewpoint”. In the following description, the image at the virtual viewpoint is referred to as a virtual viewpoint image, and the sound thereof is referred to as a virtual viewpoint sound. According to the present embodiment, the virtual viewpoint image means an image to be obtained, for example, when an object is photographed from the virtual viewpoint, and the virtual viewpoint sound means a sound to be collected at the virtual viewpoint. That is, the backend server 104 generates the virtual viewpoint image as if there is a camera that is virtual at the virtual viewpoint and the image is photographed by the camera that is virtual. Similarly, the backend server 104 generates the virtual viewpoint sound as if there is a microphone that is virtual at the virtual viewpoint and the sound is collected by the microphone that is virtual. The backend server 104 outputs the generated virtual viewpoint image and the generated virtual viewpoint sound to the virtual-viewpoint-specifying device 105 and the distribution device 106. The virtual viewpoint image according to the present embodiment is also referred to as a free viewpoint image but is not limited to an image related to a viewpoint that is freely (randomly) specified by a user. Examples of the virtual viewpoint image include an image related to a viewpoint that is selected from candidates by a user.

The backend server 104 obtains information about the position, posture, angle of view, and number of pixels of the physical camera of each sensor system 101 or another information. Furthermore, the backend server 104 acquires at least one of a position and a direction of a virtual viewpoint specified by the user. The backend server 104 has a generation unit function. The backend server 104 configured to generate information indicating a relationship between the virtual viewpoint and the image quality of the virtual viewpoint image. The backend server 104 generates various kinds of indicator information about the image quality of the virtual viewpoint image on the basis of the obtained information. The information about the position and posture of the physical camera represents the position and posture of the physical camera that is actually disposed. The information about the angle of view and number of pixels of the physical camera represents the angle of view and the number of pixels that are actually set in the physical camera. The backend server 104 outputs the generated various kinds of indicator information to the virtual-viewpoint-specifying device 105.

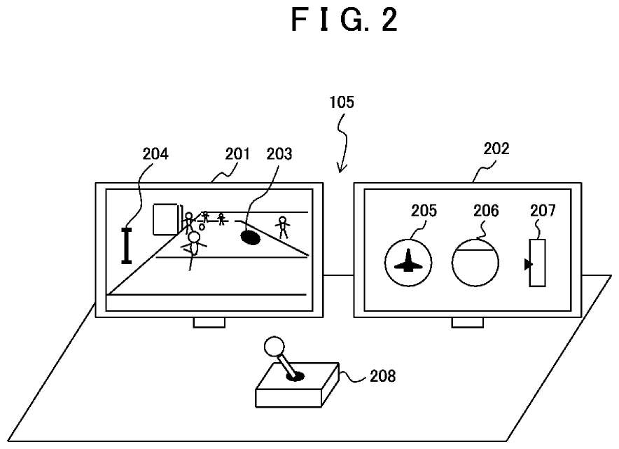

The virtual-viewpoint-specifying device 105 obtains the virtual viewpoint image, the various kinds of indicator information, and the virtual viewpoint sound that are generated by the backend server 104. The virtual-viewpoint-specifying device 105 includes an operation input device that includes, for example, a controller 208 and display devices such as display units 201 and 202, described later with reference to FIG. 2. The virtual-viewpoint-specifying device 105 has a display control unit function. The virtual-viewpoint-specifying device 105 configured to cause a display unit to display information indicating a relationship between at least one of the position and the direction of the virtual viewpoint and an image quality of the virtual viewpoint image together with the virtual viewpoint image. The virtual-viewpoint-specifying device 105 generates various indicators for display on the basis of the obtained various kinds of indicator information and overlays the various indicators on the virtual viewpoint image for display control that causes the display devices to display. The virtual-viewpoint-specifying device 105 causes the display devices to output the virtual viewpoint sound by using, for example, a built-in speaker or an external speaker. This enables an operator of the virtual-viewpoint-specifying device 105 to see the virtual viewpoint image and the various indicators and hear the virtual viewpoint sound. In the following description, the operator of the virtual-viewpoint-specifying device 105 is referred to simply as the “operator”. The operator can see the provided virtual viewpoint image and various indicators and hear the provided virtual viewpoint sound and can refer these, for example, to specify a new virtual viewpoint by using the operation input device of the virtual-viewpoint-specifying device 105. Information about the virtual viewpoint that is specified by the operator is outputted from the virtual-viewpoint-specifying device 105 to the backend server 104. That is, the operator of the virtual viewpoint can specify the new virtual viewpoint in real time by referring the virtual viewpoint image, the various indicators, and the virtual viewpoint sound that are generated by the backend server 104. For example, the virtual-viewpoint-specifying device 105 can specify, based on a user operation, at least one of a position and a direction of a virtual viewpoint for generating a virtual viewpoint image.

The distribution device 106 obtains the virtual viewpoint image and the virtual viewpoint sound that are generated by the backend server 104 and distributes the virtual viewpoint image and the virtual viewpoint sound to, for example, a terminal of an audience. For example, the distribution device 106 is managed by a broadcasting station and distributes the virtual viewpoint image and the virtual viewpoint sound to a terminal such as a television receiver of an audience. For example, the distribution device 106 is managed by a video service company and distributes the virtual viewpoint image and the virtual viewpoint sound to a terminal such as a smart phone or a tablet of an audience. An operator who specifies the virtual viewpoint may be the same as an audience who see the virtual viewpoint image related to the specified virtual viewpoint. That is, a device to which the distribution device 106 distributes the virtual viewpoint image may be integrated with the virtual-viewpoint-specifying device 105. According to the present embodiment, examples of a “user” include an operator, an audience, and a person who is not the operator or the audience.

FIG. 1B illustrates the hardware structure of the backend server 104. Devices that are included in the image-processing system 10 such as the virtual-viewpoint-specifying device 105 and the frontend server 102 have the same structure as that illustrated in FIG. 1B. The sensor systems 101, however, include the physical microphones and the physical cameras in addition to the following structure. The backend server 104 includes a CPU 111, a RAM 112, a ROM 113, and an external interface 114.

The CPU 111 controls the entire backend server 104 by using computer programs and data that are stored in the RAM 112 or the ROM 113. The backend server 104 may include a single piece or plural pieces of exclusive hardware that differs from the CPU 111 or a GPU (Graphics Processing Unit), and the GPU or the exclusive hardware may perform at least some of processes that are to be performed by the CPU 111. Examples of the exclusive hardware include an ASIC (application specific integrated circuit) and a DSP (digital signal processor). The RAM 112 temporarily stores, for example, the computer programs and data that are read from the ROM 113 and data that is provided from the outside via the external interface 114. The ROM 113 stores computer programs and data that are not needed to be changed.

The external interface 114 communicates with external devices such as the database 103, the virtual-viewpoint-specifying device 105, and the distribution device 106 and communicates with the operation input device and the display devices, not illustrated, or another device. The external interface 114 may communicate with the external devices by using a LAN (Local Area Network) cable or a SDI (Serial Digital Interface) cable in a wired manner or in a wireless manner via an antenna.

FIG. 2 schematically illustrates an example of the appearance of the virtual-viewpoint-specifying device 105.

The virtual-viewpoint-specifying device 105 includes, for example, the display unit 201 that displays the virtual viewpoint image, the display unit 202 for GUI, and the controller 208 that is operated when an operator specifies the virtual viewpoint. The virtual-viewpoint-specifying device 105 causes the display unit 201 to display, for example, the virtual viewpoint image that is obtained from the backend server 104 and a gaze-point indicator 203 and a foreground indicator 204 that are generated on the basis of the various kinds of indicator information. The virtual-viewpoint-specifying device 105 causes the display unit 202 to display, for example, a direction indicator 205, a posture indicator 206, and an altitude indicator 207 that are generated on the basis of the various kinds of indicator information. The various indicators to be displayed will be described in detail later. The various indicators may be displayed on the virtual viewpoint image or may be displayed outside the virtual viewpoint image.

The image-processing system 10 according to the present embodiment can generate the virtual viewpoint image as if there is a camera that is virtual at the virtual viewpoint and the image is photographed by the camera that is virtual and can provide the virtual viewpoint image to an audience as described above. Similarly, the image-processing system 10 can generate the virtual viewpoint sound as if there is a microphone that is virtual at the virtual viewpoint and the sound is collected by the microphone that is virtual and can provide the virtual viewpoint sound to an audience. According to the present embodiment, the virtual viewpoint is specified by an operator of the virtual-viewpoint-specifying device 105. In other words, the virtual viewpoint image is an image that is seen from the virtual viewpoint that is specified by the operator. Similarly, it can be said that the virtual viewpoint sound is a sound that is heard from the virtual viewpoint that is specified by the operator. In the following description, the camera that is virtual is referred to as the virtual camera, and the microphone that is virtual is referred to as the virtual microphone to distinguish from the physical camera and physical microphone of each sensor system 101. According to the present embodiment, the concept of the word “image” includes the concept of a video and the concept of a still image unless otherwise noted. That is, the image-processing system 10 according to the present embodiment can process both of a still image and a video. The image-processing system 10 according to the present embodiment generates both of the virtual viewpoint image and the virtual viewpoint sound, which is described by way of example. However, for example, the image-processing system 10 may generate only the virtual viewpoint image or may generate only the virtual viewpoint sound. For simplicity of description, a process for the virtual viewpoint image will be mainly described below, whereas a description of a process for the virtual viewpoint sound is omitted.

### Generation of Gaze-point Indicator and Overlaying on Virtual Viewpoint Image

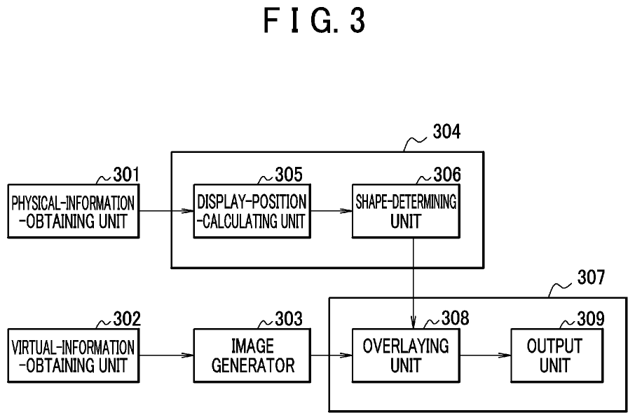

FIG. 3 is a block diagram of the information processing apparatus according to the present embodiment and mainly illustrates a functional configuration to generate the gaze-point indicator and overlay the gaze-point indicator on the virtual viewpoint image in the backend server 104 of the image-processing system 10 illustrated in FIG. 1A.

In FIG. 3, a physical-information-obtaining unit 301 obtains various kinds of information about the physical camera of each sensor system 101. Examples of the information about the physical camera include the information about the position, the posture, the angle of view, and the number of pixels as described above. The position and posture of the physical camera can be obtained on the basis of a positional relationship between a known point (for example, a particular object whose the position is fixed) in the photograph range of the physical camera and a point of an image that is obtained by photographing the point by the physical camera, which is a method called camera calibration. Alternatively, in the case where the sensor system 101 includes a GPS or a gyroscope, the physical-information-obtaining unit 301 may obtain the position and posture of the physical camera on the basis of information that is obtained therefrom. The angle of view and number of pixels of the physical camera may be obtained from settings of the angle of view and the number of pixels that the physical camera itself has. Some pieces of the information about the physical camera may be inputted by a user to the database 103 or the backend server 104.

A virtual-information-obtaining unit 302 obtains various kinds of information about the virtual camera at the virtual viewpoint from the virtual-viewpoint-specifying device 105. Examples of the information about the virtual camera include a position, a posture, an angle of view, and the number of pixels as in the physical camera. Since the virtual camera does not actually exist, the virtual-viewpoint-specifying device 105 generates information about the position, posture, angle of view, and number of pixels of the virtual camera at the virtual viewpoint on the basis of a specification from an operator, and the virtual-information-obtaining unit 302 obtains the generated information.

An image generator 303 obtains the photographed images (captured images) that are photographed by the physical cameras and obtains the various kinds of information about the virtual camera at the virtual viewpoint from the virtual-information-obtaining unit 302. The image generator 303 has a image-generation unit function. The image generator 303 configured to generate the virtual viewpoint image based on the images and the virtual viewpoint. The image generator 303 generates the virtual viewpoint image that is seen from the viewpoint (virtual viewpoint) of the virtual camera on the basis of the photographed images (captured images) from the physical cameras and the information about the virtual camera.

A case where a soccer game is photographed by the physical cameras is taken as an example to describe an example of generation of the virtual viewpoint image by the image generator 303. In the following description, an object such as a player or a ball is referred to as the “foreground”, and an object other than the foreground such as a soccer field (lawn) is referred to as the “background”. The image generator 303 first calculates the 3D shape and position of a foreground object, such as a player or a ball, from the photographed images that are photographed by the physical cameras. Subsequently, the image generator 303 reconstructs an image of the foreground object, such as a player or a ball, on the basis of the calculated 3D shape and the calculated position and the information about the virtual camera at the virtual viewpoint. The image generator 303 generates an image of the background, such as a soccer field, from the photographed images that are photographed by the physical cameras. The image generator 303 generates the virtual viewpoint image by overlaying the reconstructed image of the foreground on the generated image of the background.

An indicator generator 304 obtains the information about each physical camera from the physical-information-obtaining unit 301 and generates the gaze-point indicator 203 illustrated in FIG. 2 based on the obtained information. The gaze-point indicator 203 is one of the various indicators based on the position, posture, angle of view, and number of pixels of the physical camera. For this reason, the indicator generator 304 includes a display-position-calculating unit 305 and a shape-determining unit 306. The display-position-calculating unit 305 calculates a position at which the gaze-point indicator 203 illustrated in FIG. 2 is to be displayed. The shape-determining unit 306 determines the shape of the gaze-point indicator 203 to be displayed at the position that is calculated by the display-position-calculating unit 305.

The display-position-calculating unit 305 first obtains the information about the position and posture of each physical camera from the physical-information-obtaining unit 301 and calculates a position (referred to below as a gaze point) that the physical camera photographs on the basis of the information about the position and the posture. At this time, the display-position-calculating unit 305 obtains the direction of an optical axis of the physical camera on the basis of the information about the posture of the physical camera. The display-position-calculating unit 305 also obtains an intersection point between the optical axis of the physical camera and a field surface on the basis of the information about the position of the physical camera, and the intersection point is determined to be the gaze point of the physical camera. Subsequently, the display-position-calculating unit 305 groups the physical cameras into a gaze point group if the distance between the gaze points that are determined for the respective physical cameras is within a predetermined distance. In the case where there are the gaze point groups, the display-position-calculating unit 305 obtains a central point between the gaze points related to the respective physical cameras in the same gaze point group as to every gaze point group and determines that each central point is the position at which the gaze-point indicator 203 is to be displayed. That is, the position at which the gaze-point indicator 203 is to be displayed is near the gaze point of each physical camera, which photographs a location corresponding to this position.

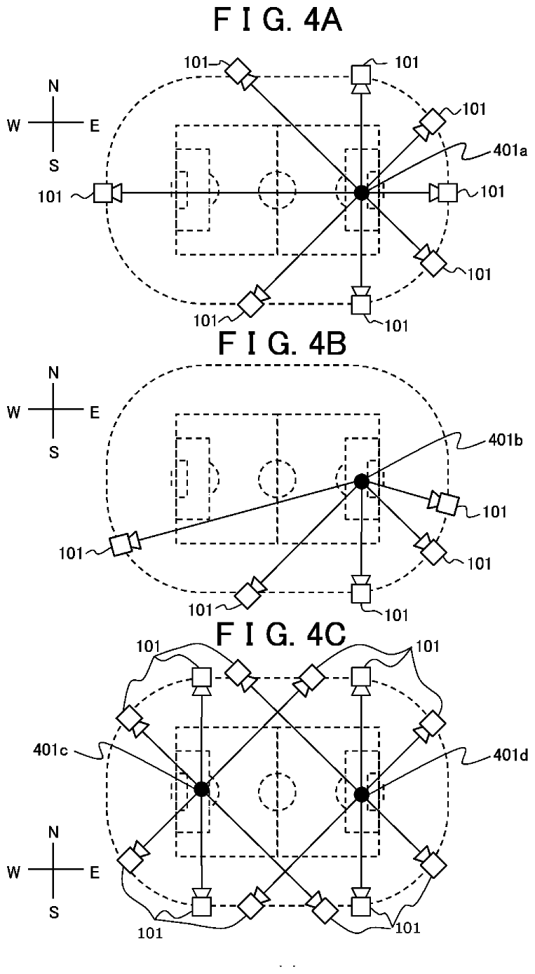

FIG. 4A to FIG. 4C illustrate examples of the position at which the gaze-point indicator 203 is displayed. FIG. 4A illustrates an example in which eight sensor systems 101 (that is, eight physical cameras) are arranged on the circumference of the soccer field. In the case of FIG. 4A, the distance between the gaze points of the eight physical cameras is within a predetermined distance, and one gaze point group is created. Consequently, in the example in FIG. 4A, the center of the gaze point group is a position 401a at which the gaze-point indicator 203 is displayed. FIG. 4B illustrates an example in which five sensor systems 101 (five physical cameras) are arranged near a substantially south semicircle of the soccer field. In the case of FIG. 4B, the distance between the gaze points of the five physical cameras is within a predetermined distance, and one gaze point group is created. Consequently, in the example in FIG. 4B, the center of the gaze point group is a position 401b at which the gaze-point indicator 203 is displayed. FIG. 4C illustrates an example in which twelve sensor systems 101 (twelve physical cameras) are arranged on the circumference of the soccer field. In the case of FIG. 4C, the distance between the gaze points of the six physical cameras near a substantially west semicircle of the soccer field is within a predetermined distance, and one gaze point group is created. Furthermore, in the case of FIG. 4C, the distance between the gaze points of the six physical cameras near a substantially east semicircle of the soccer field is within a predetermined distance, and the other gaze point group is created. Consequently, in the example in FIG. 4C, the centers of the two gaze point groups are positions 401c and 401d at which the gaze-point indicator 203 is displayed.

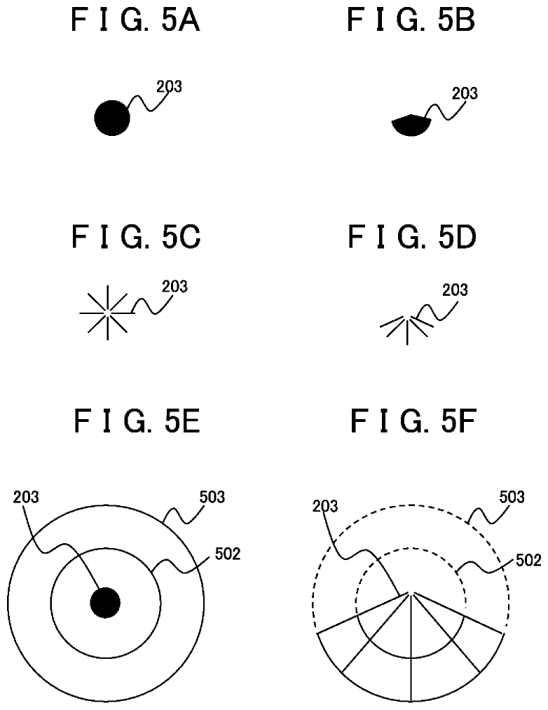

The shape-determining unit 306 determines that the shape of the gaze-point indicator 203 to be displayed at the position that is calculated by the display-position-calculating unit 305 is, for example, any one of shapes illustrated in FIG. 5A to FIG. 5F.

FIG. 5A and FIG. 5B illustrate examples of the shape of the gaze-point indicator 203 that is based on a circular shape. The shape in FIG. 5A is an example of the shape of the gaze-point indicator 203, for example, in the case where the physical cameras are arranged as illustrated in FIG. 4A. In the example in FIG. 4A, the physical cameras are arranged on the circumference of the soccer field, and the shape of the gaze-point indicator 203 is a circular shape that represents the circumference of the soccer field. The shape in FIG. 5B is an example of the shape of the gaze-point indicator 203, for example, in the case where the physical cameras are arranged as illustrated in FIG. 4B. In the example in FIG. 4B, the physical cameras are arranged near the substantially south semicircle of the soccer field, and the shape of the gaze-point indicator 203 is a shape that represents the substantially south semicircle of the soccer field. That is, the shape in FIG. 5B is formed by leaving a portion corresponding to the physical cameras that are arranged near the substantially south semicircle and that belong to the gaze point group in the example in FIG. 4B and removing the other portion from the circular shape that represents the soccer field.

The virtual viewpoint image is generated on the basis of the images that are photographed by the physical cameras. For this reason, the virtual viewpoint image can be generated when the virtual viewpoint image is near the physical cameras. However, no virtual viewpoint images near locations at which the physical cameras are not arranged can be generated. That is, in the case where the physical cameras are arranged as illustrated in FIG. 4A, the virtual viewpoint image can be generated with respect to the substantially entire circumference of the soccer field. In the case of the example of the arrangement in FIG. 4B, however, no virtual viewpoint images near a substantially north semicircle, where the physical cameras are not arranged, can be generated. For this reason, the gaze-point indicator 203 that has the shape illustrated in FIG. 5A or FIG. 5B is displayed. This enables an operator to know a range in which the virtual viewpoint image can be generated.

FIG. 5C and FIG. 5D illustrate examples in which the shape of the gaze-point indicator 203 is based on lines that represent the optical axes of the physical cameras. In FIG. 5C and FIG. 5D, the lines in the figures correspond to the respective optical axes of the physical cameras. The shape illustrated in FIG. 5C is an example of the shape of the gaze-point indicator 203 in the case where the physical cameras are arranged as illustrated in FIG. 4A. Since the physical cameras are arranged on the circumference of the soccer field in the example in FIG. 4A as described above, the gaze-point indicator 203 has a shape that is illustrated by eight lines that represent the respective optical axes of the eight physical cameras that are arranged on the circumference of the soccer field. The shape in FIG. 5D is an example of the shape of the gaze-point indicator 203 in the case where the physical cameras are arranged as illustrated in FIG. 4B. Since the five physical cameras are arranged near the substantially south semicircle of the soccer field in the example in FIG. 4B, the gaze-point indicator 203 has a shape that is illustrated by five lines that represent the respective optical axes of the five physical cameras that are arranged near the substantially south semicircle of the soccer field. Also, in the case of the examples in FIG. 5C and FIG. 5D, an operator can know the range of the virtual camera in which the virtual viewpoint image can be generated as in the above examples in FIG. 5A and FIG. 5B.

Since the virtual viewpoint image is generated on the basis of the images that are photographed by the physical cameras as described above, the generated virtual viewpoint image when the virtual viewpoint image is near a location at which the physical cameras are densely arranged can have an image quality higher than that when the virtual viewpoint image is near a location at which the physical cameras are sparsely arranged. Since the shape of the gaze-point indicator 203 is illustrated by the lines that represent the optical axes of the physical cameras as illustrated in FIG. 5C and FIG. 5D, an operator can know whether the physical cameras are densely or sparsely arranged. That is, in these examples, the operator can know a range in which a virtual viewpoint image that has a higher image quality can be generated.

Regarding the examples of the shape of the gaze-point indicator 203 illustrated in FIG. 5C and FIG. 5D, the shape-determining unit 306 may change the length of each line that represents the optical axis of the corresponding physical camera on the basis of, for example, the focal length of the physical camera or the number of pixels thereof. For example, the length of the line that represents the optical axis may be increased as the angle of view decreases (the focal length increases), or the length of the line that represents the optical axis may be increased as the number of pixels increases. The physical camera can typically increase the size of the photographed foreground as the focal length increases and is unlikely to reduce the image quality as the number of pixels increases even when the size of the foreground is increased. In addition, even when the size of the foreground of the virtual viewpoint image is increased, the image is more unlikely to fail as the size of the foreground that is photographed by the physical camera increases. In the case where the length of the line that represents the optical axis of the corresponding physical camera is changed on the basis of the focal length of the physical camera or the number of pixels thereof, an operator can know information about the physical camera (such as the angle of view and the number of pixels) to estimate the maximum size of the foreground.

FIG. 5E and FIG. 5F illustrate examples in which the shape of the gaze-point indicator 203 includes a first boundary line 502 and a second boundary line 503 that represent boundaries across which the image quality of the virtual viewpoint image changes. The shape in FIG. 5E is an example of the shape of the gaze-point indicator 203 in the case where the physical cameras are arranged as illustrated in FIG. 4A, and is a circular shape that represents the circumference of the soccer field as in the above example in FIG. 5A. The shape in FIG. 5F is an example of the shape of the gaze-point indicator 203 in the case where the physical cameras are arranged as illustrated in FIG. 4B, and is a shape that is illustrated by the five lines that represent the optical axes of the five physical cameras that are arranged on the substantially south semicircle of the soccer field as in the above example in FIG. 5D. In the examples in FIG. 5E and FIG. 5F, the image quality of the generated virtual viewpoint image is classified into, for example, three qualities of a high quality, a medium quality, and a low quality. The range that is surrounded by the first boundary line 502 is a high image quality range, the range that is surrounded by the second boundary line 503 is a medium image quality range, and the range outside the second boundary line 503 is a low image quality range.

One of factors that determine the image quality of the virtual viewpoint image depends on how many physical cameras photograph the images to generate the virtual viewpoint image. Accordingly, the boundary lines that represent the image quality of the virtual viewpoint image are approximated, for example, in the following manner. A case where the number of the physical cameras is NA and a case where the number of the physical cameras is NB are taken as examples. The values of NA and NB satisfy NA>NB and are empirically obtained. For example, a range that is photographed by NA or more physical cameras is represented by the first boundary line 502, and a range that is photographed by NB or more physical cameras is represented by the second boundary line 503. In the case where the gaze-point indicator 203 includes the boundary lines that represent the image quality of the virtual viewpoint image as above, an operator can know a range in which a virtual viewpoint image that has a high image quality can be generated. The gaze-point indicator 203 to be displayed is not limited to the examples in FIG. 5A to FIG. 5F provided that the position and direction of the virtual viewpoint that enables a virtual viewpoint image that has a high image quality to be generated can be specified by the gaze-point indicator 203. The image-processing system 10 may change the shape of the gaze-point indicator 203 to be displayed on the basis of a user operation.

Referring back to FIG. 3, an indicator-outputting unit 307 overlays the gaze-point indicator 203 on the virtual viewpoint image and outputs an overlaying image to the virtual-viewpoint-specifying device 105. The indicator-outputting unit 307 includes a overlaying unit 308 and an output unit 309.

The overlaying unit 308 overlays the gaze-point indicator 203 that is generated by the indicator generator 304 on the virtual viewpoint image that is generated by the image generator 303. For example, the overlaying unit 308 overlays the gaze-point indicator 203 on the virtual viewpoint image in a manner in which the gaze-point indicator 203 is projected on the virtual viewpoint image by using a perspective projection matrix that is obtained from the position, posture, angle of view, and number of pixels of the virtual camera.

The output unit 309 outputs the virtual viewpoint image on which the gaze-point indicator 203 is overlaid by the overlaying unit 308 to the virtual-viewpoint-specifying device 105. This enables the display unit 201 of the virtual-viewpoint-specifying device 105 to display the virtual viewpoint image on which the gaze-point indicator 203 is overlaid. That is, the output unit 309 controls the display unit 201 such that the display unit 201 displays the gaze-point indicator 203.

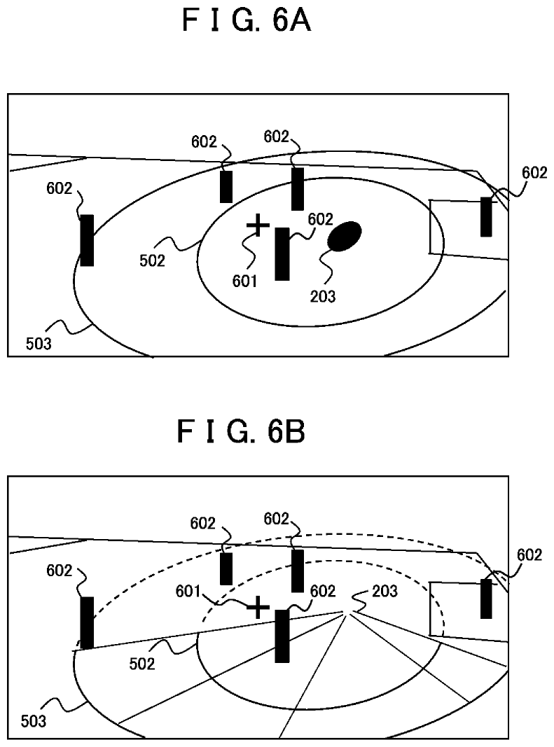

FIG. 6A and FIG. 6B illustrate examples of display of the virtual viewpoint image on which the gaze-point indicator 203 is overlaid. FIG. 6A illustrates the example of display of the virtual viewpoint image on which the gaze-point indicator 203 and the first and second boundary lines 502 and 503 that are illustrated in FIG. 5E are overlaid. FIG. 6B illustrates the example of display of the virtual viewpoint image on which the gaze-point indicator 203 and the first and second boundary lines 502 and 503 that are illustrated in FIG. 5F are overlaid. In the examples in FIG. 6A and FIG. 6B, the gaze-point indicator 203 and the first and second boundary lines 502 and 503 are overlaid on the virtual viewpoint image that includes the background of the soccer field and foregrounds 602 such as a player and a ball. The image of the foreground 602 that is located inside the boundary line 502 is generated to have a high image quality. The images of the foregrounds 602 that are located between the boundary line 502 and the boundary line 503 are generated to have a medium image quality. The image of the foreground 602 that is located outside the boundary line 503 is generated to have a low image quality. A gaze point 601 (the center of the virtual viewpoint image) of the virtual camera is also overlaid on the virtual viewpoint images in FIG. 6A and FIG. 6B. In the case of the gaze-point indicator 203 and the first and second boundary lines 502 and 503 illustrated in FIG. 6A and FIG. 6B, the second boundary line 503 that represents that the image quality decreases extends in the left direction. For this reason, in the case of the examples of display in FIG. 6A and FIG. 6B, the foreground 602 near the right edge in FIG. 6A and FIG. 6B moves to the outside of the second boundary line 503 when an operator further pans (moves the gaze point 601 in the left direction) the virtual camera in the left direction, and the operator can know, in advance, that the image quality is reduced. For example, in the case of the example of display in FIG. 6B, the operator can know, in advance, that the virtual viewpoint image cannot be generated from the opposite side (near the north semicircle of the soccer field). In addition, in the case of the examples of display in FIG. 6A and FIG. 6B, the gaze point 601 of the virtual camera is also overlaid and displayed, and the operator can know a relationship between the direction of each physical camera and the direction of the virtual camera.

With the functional configuration in FIG. 3, the case where the gaze-point indicator 203 is overlaid on the virtual viewpoint image and an overlaying image is outputted to the virtual-viewpoint-specifying device 105 is taken as an example. However, the indicator-outputting unit 307 may not overlay the gaze-point indicator 203 on the virtual viewpoint image and may output the gaze-point indicator 203 and the virtual viewpoint image separately to the virtual-viewpoint-specifying device 105. In this case, the virtual-viewpoint-specifying device 105 may generate an overlook image that overlooks a photograph region (such as a soccer stadium) by using, for example, a wire-frame method, and the gaze-point indicator 203 may be overlaid on the overlook image to display an overlaying image. Furthermore, the virtual-viewpoint-specifying device 105 may overlay an image that represents the virtual camera on the overlook image. In this case, an operator can know a positional relationship between the virtual camera and the gaze-point indicator 203. That is, the operator can know a range that can be photographed and the range of a high image quality.

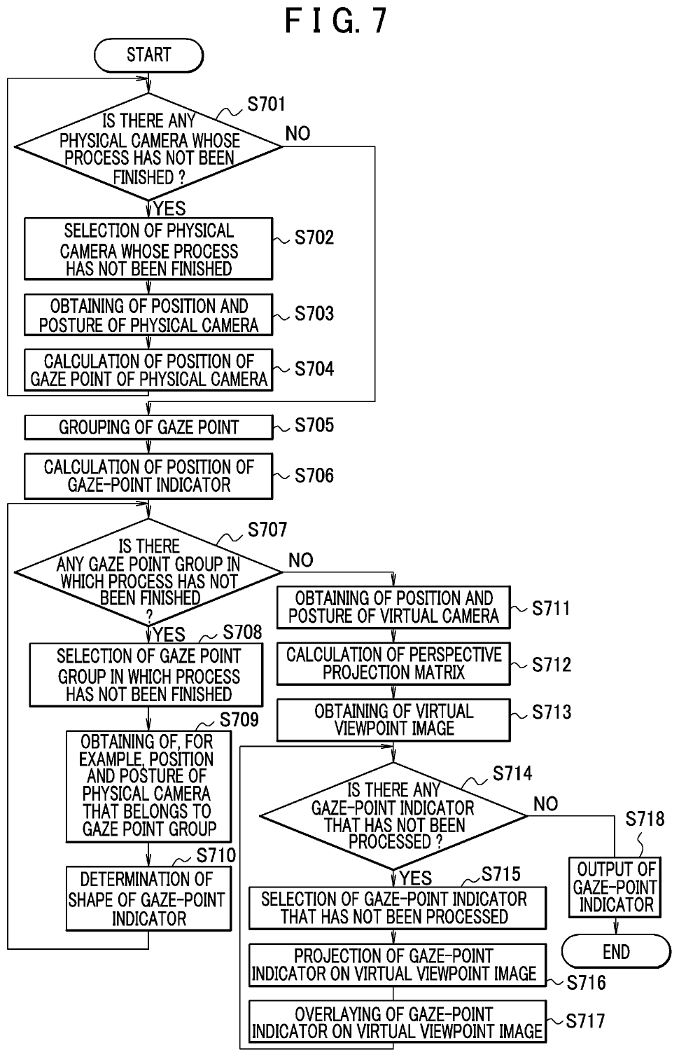

FIG. 7 is a flowchart illustrating procedures for processing of the information processing apparatus according to the present embodiment. The flowchart in FIG. 7 illustrates the flow of processes until the gaze-point indicator 203 is generated and overlaid on the virtual viewpoint image and the overlaying image is outputted as described with reference to the functional configuration illustrated in FIG. 3. The processes in the flowchart in FIG. 7 may be performed by software or hardware. Some of the processes may be performed by software, and the other processes may be performed by hardware. In the case where the processes are performed by software, a program according to the present embodiment, which is stored in, for example, the ROM 113, is run by, for example, the CPU 111. The program according to the present embodiment may be prepared in advance in, for example, the ROM 113, may be read from, for example, a semiconductor memory that is installable and removable, or may be downloaded from a network such as the internet not illustrated. The same is true for the other flowcharts described later.

In step S701, the display-position-calculating unit 305 of the indicator generator 304 determines whether there is any physical camera whose calculation of the position of display has not been finished. In the case where the display-position-calculating unit 305 determines that there are no physical cameras whose the process has not been finished, the flow proceeds to step S705. In the case where the display-position-calculating unit 305 determines that there is at least one physical camera whose the process has not been finished, the flow proceeds to step S702.

In step S702, the display-position-calculating unit 305 selects the physical camera whose the process has not been finished. Subsequently, the flow proceeds to step S703.

In step S703, the display-position-calculating unit 305 obtains information about the position and posture of the physical camera that is selected in step S702 via the physical-information-obtaining unit 301. Subsequently, the flow proceeds to step S704.

In step S704, the display-position-calculating unit 305 calculates the position of the gaze point of the physical camera that is selected in step S702 by using the obtained information about the position and posture of the physical camera. After step S704, the flow of the processes of the indicator generator 304 returns to step S701.

The processes from step S702 to step S704 are repeated until it is determined in step S701 that there are no physical cameras whose the process has not been finished.

In the case where it is determined in step S701 that there are no physical cameras whose the process has not been finished and the flow proceeds to step S705, the display-position-calculating unit 305 groups the physical cameras into a gaze point group if the distance between the gaze points of the physical cameras, which are calculated as to every physical camera, is within a predetermined distance. After step S705, the flow of the processes of the display-position-calculating unit 305 proceeds to step S706.

In step S706, the display-position-calculating unit 305 calculates the center of the gaze points of the physical cameras in every gaze point group and determines that the center is the position at which the gaze-point indicator 203 is to be displayed. After step S706, the flow of the processes of the indicator generator 304 proceeds to step S707.

In step S707, the shape-determining unit 306 of the indicator generator 304 determines whether there is any gaze point group in which the shape of the gaze-point indicator has not been determined. In the case where it is determined in step S707 that there is at least one gaze point group in which the process has not been finished, the flow of the processes of the shape-determining unit 306 proceeds to step S708. In the case where the shape-determining unit 306 determines in step S707 that there are no gaze point groups in which the process has not been finished, the flow proceeds to step S711 at which a process of the indicator-outputting unit 307 is performed.

In step S708, the shape-determining unit 306 selects the gaze point group in which the process has not been finished, and the flow proceeds to step S709.

In step S709, the shape-determining unit 306 obtains information about the position, posture, angle of view, and number of pixels of each physical camera that belongs to the gaze point group that is selected in step S708 or another information from the physical-information-obtaining unit 301 via the display-position-calculating unit 305. Subsequently, the flow proceeds to step S710.

In step S710, the shape-determining unit 306 determines the shape of the gaze-point indicator related to the gaze point group that is selected in step S708 on the basis of, for example, the position, the posture, the angle of view, and the number of pixels that are obtained. After step S710, the flow of the processes of the indicator generator 304 returns to step S707.

The processes from step S708 to step S710 are repeated until it is determined in step S707 that there are no gaze point groups in which the process has not been finished. Consequently, the gaze-point indicator for each gaze point group is obtained.

In the case where it is determined in step S707 that there are no gaze point groups in which the process has not been finished and the flow proceeds to step S711, the overlaying unit 308 of the indicator-outputting unit 307 obtains the information about the position, posture, angle of view, and number of pixels of the virtual camera or another information from the virtual-information-obtaining unit 302 via the image generator 303.

Subsequently, in step S712, the overlaying unit 308 calculates the perspective projection matrix from the position, posture, angle of view, and number of pixels of the virtual camera that are obtained in step S711.

Subsequently, in step S713, the overlaying unit 308 obtains the virtual viewpoint image that is generated by the image generator 303.

Subsequently, in step S714, the overlaying unit 308 determines whether there is any gaze-point indicator that has not been overlaid on the virtual viewpoint image. In the case where the overlaying unit 308 determines in step S714 that there are no gaze-point indicators that have not been processed, the flow of the processes of the indicator-outputting unit 307 proceeds to step S718 at which a process of the output unit 309 is performed. In the case where it is determined in step S714 that there is at least one gaze-point indicator that has not been processed, the flow of the processes of the overlaying unit 308 proceeds to step S715.

In step S715, the overlaying unit 308 selects the gaze-point indicator that has not been processed. Subsequently, the flow proceeds to step S716.

In step S716, the overlaying unit 308 projects the gaze-point indicator that is selected in step S715 on the virtual viewpoint image by using the perspective projection matrix. Subsequently, the flow proceeds to step S717.

In step S717, the overlaying unit 308 overlays the gaze-point indicator that is projected in step S716 on the virtual viewpoint image. After step S717, the flow of the processes of the overlaying unit 308 returns to step S714.

The processes from step S715 to step S717 are repeated until it is determined in step S714 that there are no gaze-point indicators that have not been processed.

In the case where it is determined in step S714 that there are no gaze-point indicators that have not been processed and the flow proceeds to step S718, the output unit 309 outputs the virtual viewpoint image on which the gaze-point indicator is overlaid to the virtual-viewpoint-specifying device 105.

### Generation of Foreground Indicator and Overlaying on Virtual Viewpoint Image

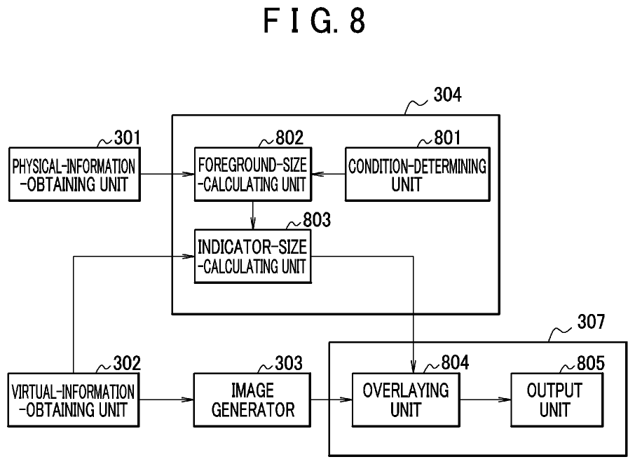

FIG. 8 is a block diagram of the information processing apparatus according to the present embodiment and mainly illustrates a functional configuration to generate the foreground indicator and overlay the foreground indicator on the virtual viewpoint image in the backend server 104 of the image-processing system 10 illustrated in FIG. lA and FIG. 1B.

In FIG. 8, the physical-information-obtaining unit 301, the virtual-information-obtaining unit 302, and the image generator 303 are the same as functional units that are described with reference to FIG. 3, and a description thereof is omitted. In FIG. 8, functional units that differ from those in FIG. 3 are the indicator generator 304 and the indicator-outputting unit 307.

The indicator generator 304 in FIG. 8 generates the foreground indicator 204 illustrated in FIG. 2 as one of the various indicators based on the information about each physical camera. For this reason, the indicator generator 304 includes a condition-determining unit 801, a foreground-size-calculating unit 802, and an indicator-size-calculating unit 803.

The condition-determining unit 801 determines a foreground condition that a foreground (foreground object) on which the foreground indicator is based satisfies. The foreground condition means the position and size of the foreground. The position of the foreground is determined in consideration for a point of interest when the virtual viewpoint image is generated. In the case where a virtual viewpoint image of a soccer game is generated, examples of the position of the foreground include a goalmouth, a position on a side line, and the center of the soccer field. For example, in the case where a virtual viewpoint image of a ballet performance of children is generated, examples of the position of the foreground include the center of a stage. In some cases, the gaze point of each physical camera is focused on the point of interest. Accordingly, the gaze point of the physical camera may be determined to be the position of the foreground. The size of the foreground is determined in consideration for the size of a foreground object whose the virtual viewpoint image is to be generated. The unit of the size is a physical unit such as cm. For example, in the case where a virtual viewpoint image of a soccer game is generated, the average of the heights of players is the size of the foreground. In the case where a virtual viewpoint image of a ballet performance of children is generated, the average of the heights of the children is the size of the foreground. Specific examples of the foreground condition include a “player who is 180 centimeters tall and stands at the position of the gaze point” and a “child who is 120 centimeters tall and stands in the front row of a stage”.

The foreground-size-calculating unit 802 calculates the size (photographed-foreground size) of the foreground that satisfies the foreground condition and that is photographed by each physical camera. The unit of the photographed-foreground size is the number of pixels. For example, the foreground-size-calculating unit 802 calculates the number of pixels of a player who is 180 centimeters tall in the image that is photographed by the physical camera. The physical-information-obtaining unit 301 has obtained the position and posture of the physical camera, and the condition-determining unit 801 has made the condition of the position of the foreground known. Accordingly, the foreground-size-calculating unit 802 can indirectly calculate the photographed-foreground size by using the perspective projection matrix. The foreground-size-calculating unit 802 may obtain the photographed-foreground size directly from the image that is photographed by the physical camera after the foreground that satisfies the foreground condition is actually arranged in the photograph range.

The indicator-size-calculating unit 803 calculates the size of the foreground indicator from the photographed-foreground size on the basis of the virtual viewpoint. The unit of the size is the number of pixels. For example, the indicator-size-calculating unit 803 calculates the size of the foreground indicator by using information about the calculated photographed-foreground size and the position and posture of the virtual camera. At this time, the indicator-size-calculating unit 803 first selects at least one physical camera whose the position and the posture are close to those of the virtual camera. When the physical camera is selected, the indicator-size-calculating unit 803 may select the physical camera whose the position and the posture are closest thereto, may select some physical cameras that are within a certain range from the virtual camera, or may select all of the physical cameras. The indicator-size-calculating unit 803 determines the size of the foreground indicator to be the average photographed-foreground size of at least one selected physical camera.

The indicator-outputting unit 307 in FIG. 8 outputs the generated foreground indicator to the virtual-viewpoint-specifying device 105. The indicator-outputting unit 307 according to the present embodiment includes a overlaying unit 804 and an output unit 805.

The overlaying unit 804 overlays the foreground indicator that is generated by the indicator generator 304 on the virtual viewpoint image that is generated by the image generator 303. For example, the position at which the foreground indicator is overlaid is the left edge at which the foreground indicator does not block the virtual viewpoint image.

The output unit 805 outputs the virtual viewpoint image on which the foreground indicator is overlaid to the virtual-viewpoint-specifying device 105. The virtual-viewpoint-specifying device 105 obtains the virtual viewpoint image on which the foreground indicator is overlaid and causes the display unit 201 to display an overlaying image.

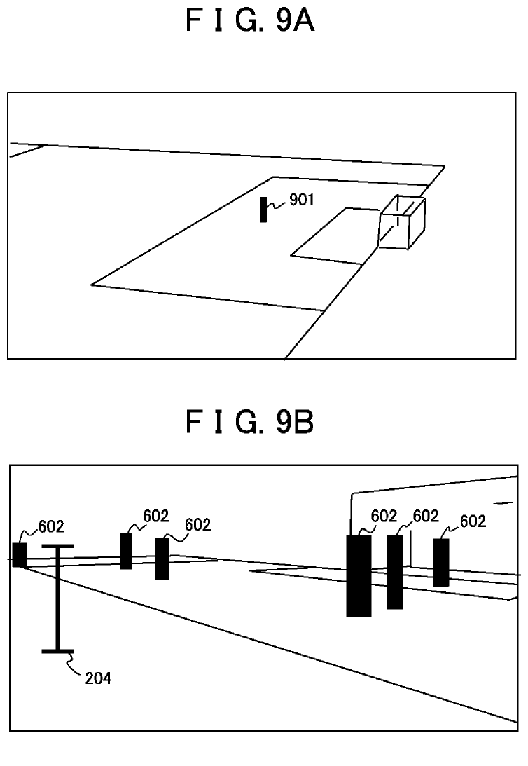

FIG. 9A and FIG. 9B are used to describe examples of display of the virtual viewpoint image on which the foreground indicator 204 is overlaid and illustrate the relationship between the size of the foreground that is photographed by one of the physical cameras and the size of the foreground indicator 204. Here, the number of pixels of the physical camera is, for example, a so-called 8K (7680 pixels×4320 pixels). The number of pixels of the virtual camera is a so-called 2K (1920 pixels×1080 pixels). That is, the virtual viewpoint image of 2K is generated from the photographed images of 8K that are photographed by the physical cameras. The foreground condition is a “player who is 180 centimeters tall and stands at the gaze point”. FIG. 9A illustrates an example of a photographed image that is obtained by image capturing a foreground 901 that satisfies the foreground condition by the physical camera. The photographed-foreground size of the foreground 901 in the photographed image is 395 pixels. The 395 pixels mean a size in height. Here, only the size in height is considered, and a description of the size in width is omitted. FIG. 9B illustrates an example in which the foreground indicator 204 is overlaid on a virtual viewpoint image that includes the background of the soccer field and the foregrounds 602 such as a player and a ball. The size of the foreground indicator 204 is 395 pixels as with the photographed-foreground size. That is, although the size of the foreground indicator 204 is 395 pixels as with the photographed-foreground size, a screen occupancy differs therebetween because the number of pixels differs between each physical camera and the virtual camera.

When the size of each foreground 602 in the virtual viewpoint image is excessively increased, the image quality is reduced. The foreground indicator 204 enables the maximum size of the foreground to be estimated without reducing the image quality of the virtual viewpoint image. For example, the foreground indicator 204 represents a size standard related to an image quality of a foreground object that is included in the virtual viewpoint image. When the size of the foreground 602 is larger than that of the foreground indicator 204, the number of pixels is insufficient, which results in reduction in the image quality as in a so-called digital zoom. That is, the displayed foreground indicator 204 enables an operator to know a range in which the size of the foreground can be increased while the image quality is maintained.

In some cases, the physical cameras in the image-processing system 10 have different settings. For example, in the case where the physical cameras have different angles of view, the physical camera that has a large angle of view (short focal length) has a wide photograph range, and the range in which the virtual viewpoint image is generated is increased accordingly. However, the photographed-foreground size of the foreground that is photographed by the physical camera that has a large angle of view is decreased. The physical camera that has a small angle of view (long focal length) has a narrow photograph range, but the photographed-foreground size is increased. In the case of the structure in FIG. 8, the difference in the settings of the physical cameras can be dealt with in a manner in which the indicator-size-calculating unit 803 selects the physical camera whose the position and the posture are close to those of the virtual camera. For example, in the case where the virtual camera is near the physical camera that has a small angle of view, the size of the foreground indicator 204 is increased. Accordingly, an operator can know a range in which the size of the foreground is appropriately increased without reducing the image quality on the basis of the settings of the physical cameras.

The indicator-size-calculating unit 803 may make an adjustment by multiplying the photographed-foreground size by a coefficient before the size of the foreground indicator 204 is calculated. In this case, when the coefficient is more than 1.0, the size of the foreground indicator 204 is increased. For example, in the case where there are no problems of the image quality of the virtual viewpoint image, such as the case of good photograph conditions, when the coefficient is more than 1.0, the size of each foreground 602 is increased, and a virtual viewpoint image that is more impressive can be generated. However, when the coefficient is less than 1.0, the size of the foreground indicator 204 is decreased. For example, in the case where the image quality of the virtual viewpoint image is reduced, such as the case of insufficient photograph conditions, the coefficient is set to less than 1.0, and the size of the foreground 602 is decreased. This enables the image quality of the virtual viewpoint image to be prevented from being reduced.

With the functional configuration in FIG. 8, the case where the foreground indicator 204 is overlaid on the virtual viewpoint image and overlaying image is outputted to the virtual-viewpoint-specifying device 105 is taken as an example. However, the indicator-outputting unit 307 may not overlay the foreground indicator 204 on the virtual viewpoint image and may output the foreground indicator 204 and the virtual viewpoint image separately to the virtual-viewpoint-specifying device 105. In this case, the virtual-viewpoint-specifying device 105 may cause, for example, the display unit 202 for GUI to display the obtained foreground indicator 204.

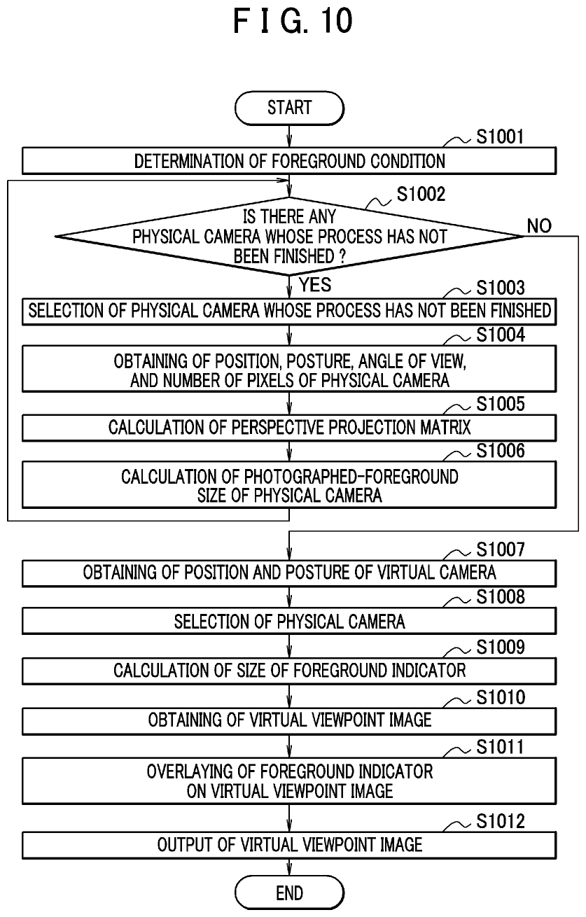

FIG. 10 is a flowchart illustrating procedures for processing of the information processing apparatus according to the present embodiment and illustrates the flow of processes until the foreground indicator is generated and overlaid on the virtual viewpoint image, and the overlaying image is outputted with the functional configuration illustrated in FIG. 8.

In step S1001 in FIG. 10, the condition-determining unit 801 of the indicator generator 304 determines the foreground condition that the foreground on which the foreground indicator is based satisfies. For example, the condition-determining unit 801 determines the foreground condition such as a “player who is 180 centimeters tall and stands at the gaze point” as described above.

Subsequently, in step S1002, the foreground-size-calculating unit 802 determines whether there is any physical camera whose calculation of the photographed-foreground size has not been finished. In the case where the foreground-size-calculating unit 802 determines that there are no physical cameras whose the process has not been finished, the flow proceeds to step S1007. In the case where the foreground-size-calculating unit 802 determines that there is at least one physical camera whose the process has not been finished, the flow proceeds to step S1003.

In step S1003, the foreground-size-calculating unit 802 selects the physical camera whose the process has not been finished. Subsequently, the flow proceeds to step S1004.

In step S1004, the foreground-size-calculating unit 802 obtains information about the position, posture, angle of view, and number of pixels of the physical camera that is selected in step S1003 or another information via the physical-information-obtaining unit 301. Subsequently, the flow proceeds to step S1005.

In step S1005, the foreground-size-calculating unit 802 calculates the perspective projection matrix by using the position, the posture, the angle of view, and the number of pixels that are obtained. Subsequently, the flow proceeds to step S1006.

In step S1006, the foreground-size-calculating unit 802 calculates the photographed-foreground size of the foreground that satisfies the foreground condition that is determined in step S1001 by using the perspective projection matrix that is calculated in step S1005. After step S1006, the flow of the processes of the foreground-size-calculating unit 802 returns to step S1002.

The processes from step S1003 to step S1006 are repeated until it is determined in step S1002 that there are no physical cameras whose the process has not been finished.

In the case where it is determined in step S1002 that there are no physical cameras whose the process has not been finished and the flow proceeds to step S1007, the indicator-size-calculating unit 803 of the indicator generator 304 obtains the information about the position and posture of the virtual camera from the virtual-information-obtaining unit 302.

Subsequently, in step S1008, the indicator-size-calculating unit 803 selects one or more physical cameras whose the position and the posture are close to those of the virtual camera that are obtained in step S1007.

Subsequently, in step S1009, the indicator-size-calculating unit 803 calculates the average photographed-foreground size of the one or more physical cameras selected in step S1008 and determines the size of the foreground indicator to be the calculated average photographed-foreground size. After step S1009, the flow proceeds to step S1010 at which a process of the overlaying unit 804 of the indicator-outputting unit 307 is performed.

In step S1010, the overlaying unit 804 obtains the virtual viewpoint image from the image generator 303.

Subsequently, in step S1011, the overlaying unit 804 overlays the foreground indicator whose the size is calculated by the indicator-size-calculating unit 803 on the virtual viewpoint image that is obtained from the image generator 303.

Subsequently, in step S1012, the output unit 805 outputs the virtual viewpoint image on which the foreground indicator is overlaid in step S1011 to the virtual-viewpoint-specifying device 105.

### Generation of Direction Indicator and Overlaying on Virtual Viewpoint Image

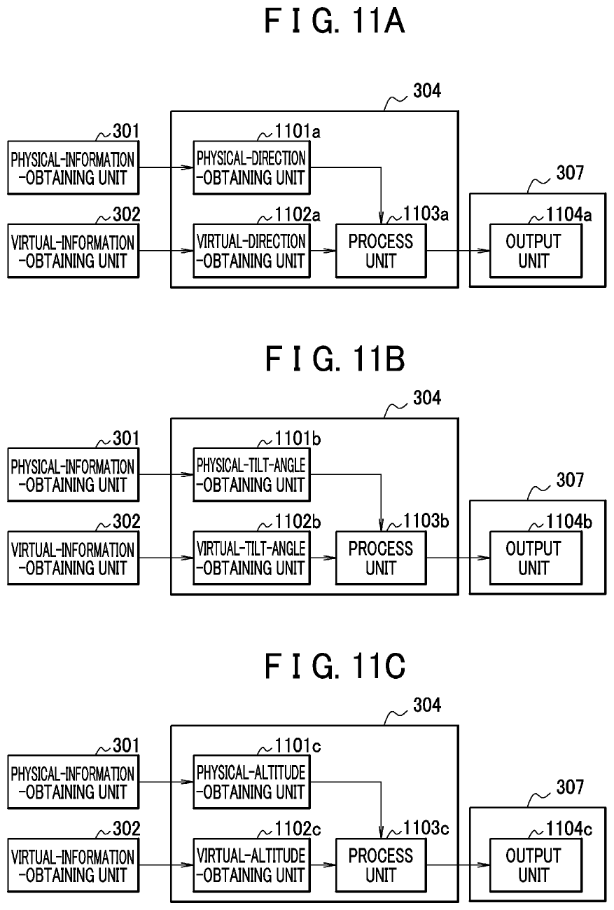

FIG. 11A is a block diagram of the information processing apparatus according to the present embodiment and mainly illustrates a functional configuration to generate and output the direction indicator in the backend server 104. In FIG. 11A, the physical-information-obtaining unit 301 and the virtual-information-obtaining unit 302 are the same as the functional units that are described with reference to FIG. 3, and a description thereof is omitted. In FIG. 11A, functional units that differ from those in FIG. 3 are the indicator generator 304 and the indicator-outputting unit 307.

The indicator generator 304 in FIG. 11A generates the direction indicator 205 illustrated in FIG. 2 as an indicator based on the direction of each physical camera. For this reason, the indicator generator 304 includes a physical-direction-obtaining unit 1101a, a virtual-direction-obtaining unit 1102a, and a process unit 1103a.

The physical-direction-obtaining unit 1101a obtains the direction of each physical camera (direction in which the physical camera photographs) from the posture of the physical camera that is obtained by the physical-information-obtaining unit 301. The posture, which can be represented in various manners, is represented by a pan angle, a tilt angle, or a roll angle. For example, even when the posture is represented in another manner, for example, by using a rotation matrix, the posture can be converted into the pan angle, the tilt angle, or the roll angle. Here, the pan angle corresponds to the direction of the physical camera. The physical-direction-obtaining unit 1101a obtains the pan angles as the directions of all of the physical cameras.

The virtual-direction-obtaining unit 1102a obtains the direction of the virtual camera from the posture of the virtual camera that is obtained by the virtual-information-obtaining unit 302. The virtual-direction-obtaining unit 1102a converts the posture of the virtual camera into the representation of the pan angle, the tilt angle, or the roll angle in the same manner as with the physical-direction-obtaining unit 1101a. Also, in this case, the pan angle corresponds to the direction of the virtual camera.

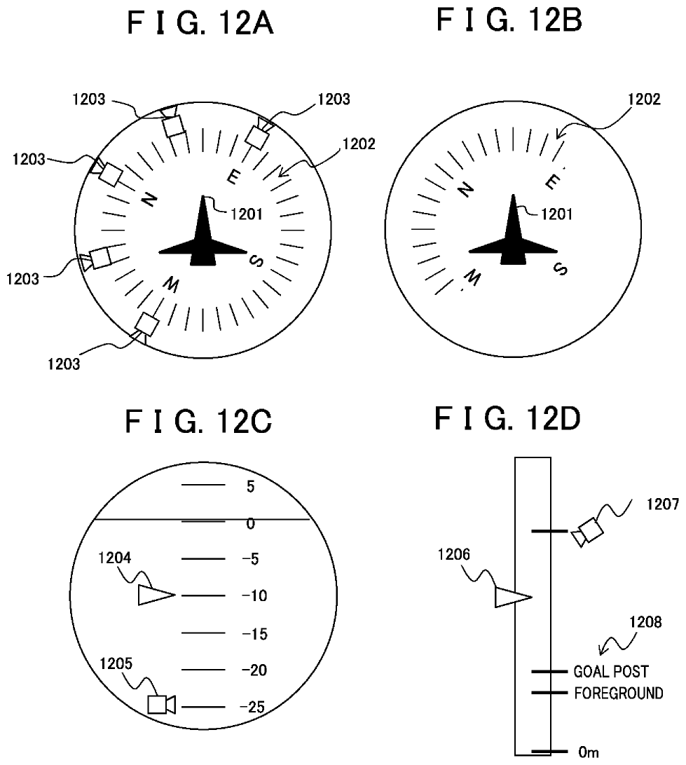

The process unit 1103a processes the direction indicator 205 that represents the direction of the virtual camera and that is illustrated in FIG. 2 on the basis of the direction of each physical camera, that is, corrects, for example, the direction that the direction indicator 205 points out. Specific examples of the process based on the direction of the physical camera are illustrated in FIG. 12A and FIG. 12B. FIG. 12A illustrates the direction indicator 205 illustrated in FIG. 2 and illustrates an example of the direction indicator that is processed in the case of the above example of the arrangement of the physical cameras in FIG. 4B. An object 1201 at the center in the direction indicator illustrated in FIG. 12A represents the direction of the virtual camera. The process unit 1103a adds objects 1203 that represent the respective directions of the physical cameras in FIG. 4B into the direction indicator, for example, at appropriate positions on a scale 1202. For example, the physical camera that is located at the center among the five physical cameras illustrated in FIG. 4B is disposed on the south side (S) of the soccer field. The physical camera at the center faces the north direction (N). Accordingly, the process unit 1103a arranges the object 1203 corresponding to the physical camera at the center such that the object 1203 faces the north direction (N). The process unit 1103a processes the direction indicator such that the objects corresponding to the other four physical cameras are arranged in the same manner as above. FIG. 12B illustrates another example of the direction indicator that is processed by the process unit 1103a in the case of the physical cameras illustrated in FIG. 4B. In the case of the example in FIG. 12B, the process unit 1103a processes the scale 1202 such that the scale 1202 fits to the direction of each physical camera. That is, in the example in FIG. 12B, the scale 1202 is within the range of the direction that each physical camera faces, and there is no scale out of the range of the direction that each physical camera faces. Since the direction indicator is processed as illustrated in FIG. 12A and FIG. 12B, an operator can know the range in which the virtual viewpoint image can be generated. In other words, the operator can know the direction in which the virtual viewpoint image cannot be generated because the physical cameras do not face the direction.

An output unit 1104a of the indicator-outputting unit 307 in FIG. 11A outputs information about the direction indicator that is generated by the indicator generator 304 to the virtual-viewpoint-specifying device 105. This enables the display unit 202, for GUI, of the virtual-viewpoint-specifying device 105 to display the direction indicator 205.

### Generation of Posture Indicator and Overlaying on Virtual Viewpoint Image

FIG. 11B is a block diagram of the information processing apparatus according to the present embodiment and mainly illustrates a functional configuration to generate and output the posture indicator in the backend server 104. In FIG. 11B, the physical-information-obtaining unit 301 and the virtual-information-obtaining unit 302 are the same as the functional units that are described with reference to FIG. 3, and a description thereof is omitted. In FIG. 11B, functional units that differ from those in FIG. 3 are the indicator generator 304 and the indicator-outputting unit 307.

The indicator generator 304 in FIG. 11B generates the posture indicator 206 illustrated in FIG. 2 as an indicator based on the posture of each physical camera. For this reason, the indicator generator 304 includes a physical-tilt-angle-obtaining unit 1101b, a virtual-tilt-angle-obtaining unit 1102b, and a process unit 1103b.

The physical-tilt-angle-obtaining unit 1101b obtains the tilt angle of each physical camera from the posture of the physical camera that is obtained by the physical-information-obtaining unit 301. As described with reference to FIG. 11A, the posture of the physical camera can be represented by the pan angle, the tilt angle, or the roll angle. Here, the physical-tilt-angle-obtaining unit 1101b obtains the tilt angle as the posture of the physical camera. The physical-tilt-angle-obtaining unit 1101b obtains the tilt angles as the postures of all of the physical cameras.

The virtual-tilt-angle-obtaining unit 1102b obtains the tilt angle as the posture of the virtual camera from the posture of the virtual camera that is obtained by the virtual-information-obtaining unit 302. The virtual-tilt-angle-obtaining unit 1102b obtains the tilt angle as the posture of the virtual camera in the same manner as with the physical-tilt-angle-obtaining unit 1101b.

The process unit 1103b processes the posture indicator 206 that represents the posture of the virtual camera and that is illustrated in FIG. 2 on the basis of the posture of each physical camera, that is, corrects, for example, the posture of the physical camera that is represented by the posture indicator 206. A specific example of the process based on the posture of the physical camera is illustrated in FIG. 12C. FIG. 12C illustrates the detail of the posture indicator 206 illustrated in FIG. 2 and illustrates an example of the posture indicator that is processed on the basis of the posture of the physical camera. An object 1204 in the posture indicator illustrated in FIG. 12C represents the posture (tilt angle) of the virtual camera. The process unit 1103b adds an object 1205 that represents the posture of one of the physical cameras into the posture indicator, for example, at an appropriate position on a scale that represents an angle. In the example in FIG. 12C, the object 1204 that represents the posture of the virtual camera exhibits a tilt angle of −10, and the object 1205 that represents the posture of the physical camera exhibits a tilt angle of −25. A main purpose of generation of the virtual viewpoint image is to generate an image that is seen from a virtual viewpoint at which no physical cameras are disposed. The posture indicator that is displayed as illustrated in FIG. 12C enables an operator to know the virtual viewpoint that differs from the viewpoint of the physical camera.

An output unit 1104b of the indicator-outputting unit 307 in FIG. 11B outputs information about the posture indicator that is generated by the indicator generator 304 to the virtual-viewpoint-specifying device 105. This enables the display unit 202, for GUI, of the virtual-viewpoint-specifying device 105 to display the posture indicator 206.

### Generation of Altitude Indicator and Overlaying on Virtual Viewpoint Image

FIG. 11C is a block diagram of the information processing apparatus according to the present embodiment and mainly illustrates a functional configuration to generate and output the altitude indicator in the backend server 104. In FIG. 11C, the physical-information-obtaining unit 301 and the virtual-information-obtaining unit 302 are the same as the functional units that are described with reference to FIG. 3, and a description thereof is omitted. In FIG. 11C, functional units that differ from those in FIG. 3 are the indicator generator 304 and the indicator-outputting unit 307.

The indicator generator 304 in FIG. 11C generates the altitude indicator 207 illustrated in FIG. 2 as an indicator based on the altitude of each physical camera. For this reason, the indicator generator 304 includes a physical-altitude-obtaining unit 1101c, a virtual-altitude-obtaining unit 1102c, and a process unit 1103c.

The physical-altitude-obtaining unit 1101c obtains an altitude at which each physical camera is disposed from the position of the physical camera that is obtained by the physical-information-obtaining unit 301. The position of the physical camera is represented, for example, by a coordinate (x, y) on a plane and the altitude (z). Accordingly, the physical-altitude-obtaining unit 1101c obtains the altitude (z). The physical-altitude-obtaining unit 1101c obtains the altitudes of all of the physical cameras.

The virtual-altitude-obtaining unit 1102c obtains the altitude of the virtual camera from the position of the virtual camera that is obtained by the virtual-information-obtaining unit 302. The virtual-altitude-obtaining unit 1102c obtains the altitude of the virtual camera in the same manner as with the physical-altitude-obtaining unit 1101c.

The process unit 1103c processes the altitude indicator 207 that represents the altitude of the virtual camera and that is illustrated in FIG. 2 on the basis of the altitude of each physical camera, that is, corrects, for example, the altitude of the physical camera that is represented by the altitude indicator 207. A specific example of the process based on the altitude of the physical camera is illustrated in FIG. 12D. FIG. 12D illustrates the detail of the altitude indicator 207 illustrated in FIG. 2 and illustrates an example of the altitude indicator that is processed on the basis of the altitude of the physical camera. An object 1206 in the altitude indicator illustrated in FIG. 12D represents the altitude of the virtual camera. The process unit 1103c adds an object 1207 that represents the altitude of one of the physical cameras into the altitude indicator, for example, at an appropriate position on a scale that represents the altitude. As in the example in FIG. 12D, the altitude indicator may include an object 1208 that represents the height of an important object within the photograph range such as a goal post on the soccer field or the foreground. The altitude indicator that is displayed as illustrated in FIG. 12D enables an operator to know the virtual viewpoint that differs from the viewpoint of the physical camera. In addition, the operator can know the altitude of the important object.

An output unit 1104c of the indicator-outputting unit 307 in FIG. 11C outputs information about the altitude indicator that is generated by the indicator generator 304 to the virtual-viewpoint-specifying device 105. This enables the display unit 202, for GUI, of the virtual-viewpoint-specifying device 105 to display the altitude indicator 207.

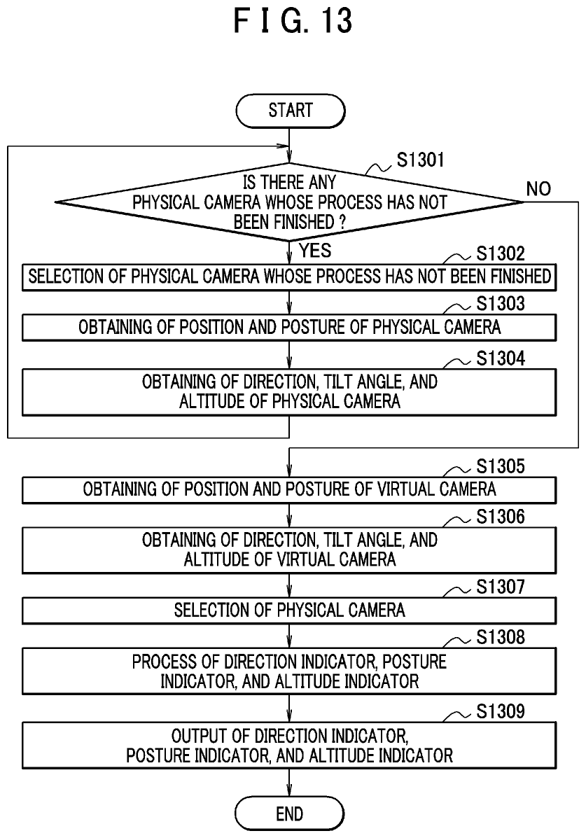

FIG. 13 is a flowchart illustrating procedures for processing of the information processing apparatus according to the present embodiment and illustrates the flow of processes until the direction indicator, the posture indicator, and the altitude indicator described above are generated and outputted. The flowchart in FIG. 13 is shared with the functional configurations in FIG. 11A, FIG. 11B, and FIG. 11C.

In step S1301 in FIG. 13, the physical-direction-obtaining unit 1101a, the physical-tilt-angle-obtaining unit 1101b, and the physical-altitude-obtaining unit 1101c determine whether there is any physical camera whose a corresponding process has not been finished. In the case where it is determined that there are no physical cameras whose the process has not been finished, the flow proceeds to step S1305. In the case where it is determined that there is at least one physical camera whose the process has not been finished, the flow proceeds to step S1302.

In step S1302, the physical-direction-obtaining unit 1101a, the physical-tilt-angle-obtaining unit 1101b, and the physical-altitude-obtaining unit 1101c select the physical camera whose the process has not been finished, and the flow proceeds to step S1303.

In step S1303, the physical-direction-obtaining unit 1101a and the physical-tilt-angle-obtaining unit 1101b obtain information about the posture of the physical camera that is selected in step S1302, and the physical-altitude-obtaining unit 1101c obtains information about the position of the physical camera that is selected in step S1302.

Subsequently, in step S1304, the physical-direction-obtaining unit 1101a obtains the direction of the physical camera on the basis of the obtained posture of the physical camera. In step S1304, the physical-tilt-angle-obtaining unit 1101b obtains the tilt angle (posture) of the physical camera on the basis of the obtained posture of the physical camera. In step S1304, the physical-altitude-obtaining unit 1101c obtains the altitude of the physical camera on the basis of the obtained position of the physical camera. After step S1304, the flow of the processes of the indicator generator 304 returns to step S1301.

The processes from step S1302 to step S1304 are repeated until it is determined in step S1301 that there are no physical cameras whose the process has not been finished.

Subsequently, when the flow proceeds to step S1305, the virtual-direction-obtaining unit 1102a and the virtual-tilt-angle-obtaining unit 1102b obtain information about the posture of the virtual camera, and the virtual-altitude-obtaining unit 1102c obtains information about the position of the virtual camera.

Subsequently, in step S1306, the virtual-direction-obtaining unit 1102a obtains the direction of the virtual camera on the basis of the obtained posture of the virtual camera. In step S1306, the virtual-tilt-angle-obtaining unit 1102b obtains the tilt angle (posture) of the virtual camera on the basis of the obtained posture of the virtual camera. In step S1306, the virtual-altitude-obtaining unit 1102c obtains the altitude of the virtual camera on the basis of the obtained position of the virtual camera. After step S1306, the flow of the process of the indicator generator 304 proceeds to step S1307.

In step S1307, the process unit 1103a selects all of the physical cameras. The process unit 1103b selects one or more physical cameras whose the position and the posture are close to the obtained position and posture of the virtual camera. Similarly, the process unit 1103c selects one or more physical cameras whose the position and the posture are close to the obtained position and posture of the virtual camera.

Subsequently, in step S1308, the process unit 1103a processes the direction indicator 205 that represents the direction of the virtual camera by using the directions of all of the physical cameras. The process unit 1103b processes the posture indicator 206 that represents the tilt angle of the virtual camera by using the tilt angle of the one or more physical cameras selected. The process unit 1103c processes the altitude indicator 207 that represents the altitude of the virtual camera by using the altitude of the one or more physical cameras selected.

Subsequently, in step S1309, the output unit 1104a outputs the direction indicator 205 that is processed by the process unit 1103a to the virtual-viewpoint-specifying device 105. The output unit 1104b outputs the posture indicator 206 that is processed by the process unit 1103b to the virtual-viewpoint-specifying device 105. The output unit 1104c outputs the altitude indicator 207 that is processed by the process unit 1103c to the virtual-viewpoint-specifying device 105.

The backend server 104 may have all of the above functional configurations in FIG. 3, FIG. 8, FIG. 11A, FIG. 11B, and FIG. 11C or may have any one of the functional configurations or a combination thereof. The backend server 104 may perform the processes of the functional configurations in FIG. 3, FIG. 8, FIG. 11A, FIG. 11B, and FIG. 11C at the same time or may perform the processes at different times.

The information processing apparatus according to present embodiment enables a user (operator) to know, in advance, operation of the virtual camera whose the image quality of the virtual viewpoint image will be decreased as described above.

In the examples described according to the present embodiment, the various indicators are generated and displayed as information about the image quality of the virtual viewpoint image. However, the various indicators that are generated and displayed may be information about the sound quality of the virtual viewpoint sound. In this case, the backend server 104 obtains information about the position, posture, sound-collected direction, and sound-collected range of a physical microphone of each sensor system 101 and generates, on the basis of the obtained information, various kinds of indicator information about the sound quality depending on the position and sound-collected direction of the physical microphone. For example, the various indicators about the sound quality are displayed. The information about the position, sound-collected direction, and sound-collected range of the physical microphone represents the position, sound-collected direction, and sound-collected range of the physical microphone that is actually disposed. The information processing apparatus according to the present embodiment enables a user (operator) to know, in advance, operation of the virtual microphone whose the sound quality of the virtual viewpoint sound will be decreased.

The above embodiment reduces the risk that the image quality of the generated virtual viewpoint image is low against expectations of the user.

### Other Embodiments

Embodiment(s) can also be realized by a computer of a system or apparatus that reads out and executes computer executable instructions (e.g., one or more programs) recorded on a storage medium (that may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™, a flash memory device, a memory card, and the like.

While exemplary embodiments have been described, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2018-090367, filed May 9, 2018, which is hereby incorporated by reference herein in its entirety.

What is claimed is:

1. An information processing apparatus comprising:
a specifying unit configured to specify, based on a user operation, at least one of a position and a direction of a virtual viewpoint for generating a virtual viewpoint image, wherein the virtual viewpoint image is generated based on images that are obtained by image capturing in a plurality of directions with a plurality of image capturing apparatuses; and
a display control unit configured to cause a display unit to display information indicating a relationship between at least one of the position and the direction of the virtual viewpoint and an image quality of the virtual viewpoint image together with the virtual viewpoint image.

2. The information processing apparatus according to claim 1, further comprising:
an image-generating unit configured to generate the virtual viewpoint image based on the images and the virtual viewpoint.

3. The information processing apparatus according to claim 1, wherein
the display control unit overlays, on the virtual viewpoint image, information indicating a relationship between the virtual viewpoint and the image quality of the virtual viewpoint image.

4. The information processing apparatus according to claim 1, further comprising:
a generation unit configured to generate information indicating a relationship between the virtual viewpoint and the image quality of the virtual viewpoint image, wherein
the display control unit causes the display unit to display the information generated by the generation unit.

5. The information processing apparatus according to claim 4, wherein
the generation unit generates the information indicating the relationship between the virtual viewpoint and the image quality of the virtual viewpoint image, based on at least one of arrangement of the plurality of image capturing apparatuses and a setting of the plurality of image capturing apparatuses.

6. The information processing apparatus according to claim 5, wherein
the generation unit generates, as the information indicating the relationship between the virtual viewpoint and the image quality of the virtual viewpoint image, a gaze-point indicator that represents a gaze point of the plurality of image capturing apparatuses.

7. The information processing apparatus according to claim 6, wherein
the generation unit determines a position at which the gaze-point indicator is displayed based on information about the arrangement of the plurality of image capturing apparatuses and the setting of the plurality of image capturing apparatuses and
the generation unit determines that a shape of the gaze-point indicator to be displayed is a shape that represents at least one of the arrangement of the plurality of image capturing apparatuses and the setting of the plurality of image capturing apparatuses.

8. The information processing apparatus according to claim 7, wherein
the generation unit specifies a plurality of gaze points based on the information about the arrangement of the plurality of image capturing apparatuses and the setting of the plurality of image capturing apparatuses and determines positions at which a plurality of gaze-point indicators corresponding to the respective gaze points are displayed.

9. The information processing apparatus according to claim 7, wherein
the generation unit determines, based on the position at which the gaze-point indicator is displayed, a boundary line that represents a boundary across which the image quality of the virtual viewpoint image changes, and
the display control unit causes the display unit to display the boundary line with the gaze-point indicator.

10. The information processing apparatus according to claim 4, wherein
the generation unit generates a foreground indicator that represents a size standard related to an image quality of a foreground object that is included in the virtual viewpoint image.

11. The information processing apparatus according to claim 10, wherein
the generation unit obtains a foreground condition that the foreground object satisfies and
the generation unit determines a size of the foreground indicator to be displayed, based on the virtual viewpoint and a size of the foreground object with respect to a photographed image that is obtained by image capturing the foreground object that satisfies the foreground condition.

12. The information processing apparatus according to claim 4, wherein
the generation unit generates a direction indicator that represents the direction of the virtual viewpoint and a direction of an image capturing apparatus that is included in the plurality of image capturing apparatuses, and
the display control unit causes the display unit to display the generated direction indicator.

13. The information processing apparatus according to claim 4, wherein
the generation unit generates a posture indicator that represents a posture of the virtual viewpoint and a posture of a image capturing apparatus that is included in the plurality of image capturing apparatuses, and
the display control unit causes the display unit to display the generated posture indicator.

14. The information processing apparatus according to claim 4, wherein
the generation unit generates an altitude indicator that represents an altitude of the virtual viewpoint and an altitude of an image capturing apparatus that is included in the plurality of image capturing apparatuses, and
the display control unit causes the display unit to display the generated altitude indicator.

15. An information processing method comprising:
specifying, based on a user operation, at least one of a position and a direction of a virtual viewpoint for generating a virtual viewpoint image;
generating the virtual viewpoint image based on images that are obtained by image capturing in a plurality of directions with a plurality of image capturing apparatuses; and
displaying information indicating a relationship between at least one of the position and the direction of the virtual viewpoint and an image quality of the virtual viewpoint image together with the virtual viewpoint image.

16. A non-transitory computer-readable storage medium storing a program for causing a computer to execute an information processing method, the information processing method comprising:
specifying, based on a user operation, at least one of a position and a direction of a virtual viewpoint for generating a virtual viewpoint image;
generating the virtual viewpoint image based on images that are obtained by image capturing in a plurality of directions with a plurality of image capturing apparatuses; and
displaying information indicating a relationship between at least one of the position and the direction of the virtual viewpoint and an image quality of the virtual viewpoint image together with the virtual viewpoint image.
